(19) United States
(12) Patent Application Publication
(10) Pub. No.: US 2010/0109870 A1
(43) Pub. Date: May 6, 2010

(54) MULTIFUNCTION PORTABLE ELECTRONIC DEVICE AND ANTI-THEFT METHOD THEREOF

(75) Inventor: HSING-YUAN HSIEH, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/567,918

(22) Filed: Sep. 28, 2009

(30) Foreign Application Priority Data
Oct. 30, 2008 (CN) 200810305313.2

(51) Int. Cl. G08B 13/14

(52) U.S. Cl. 340/572.4

(57) ABSTRACT

A portable electronic device includes a transmitting unit and a receiving unit separate from the transmitting unit. The receiving unit can communicate with the transmitting unit within a predetermined work distance, and generate an alarming signal when the transmitting unit is outside of the predetermined work distance.

### BACKGROUND

1. Technical Field

The present disclosure generally relates to portable electronic devices, particularly to a multifunction anti-theft portable electronic device.

2. Description of Related Art

With the developments of wireless communication and information processing technologies, portable electronic devices such as mobile phones and personal digital assistants (PDAs) are now in widespread use, and consumers may now enjoy the full convenience of high tech products almost anytime and anywhere. However, these portable electronic devices may easily be lost or stolen because of their small size.

Therefore, there is room for improvement within the art.

### BRIEF DESCRIPTION OF THE DRAWINGS

Many aspects of the multifunction portable electronic device and the anti-theft method thereof can be better understood with reference to the following drawings. The components in the drawings are not necessarily drawn to scale, the emphasis instead being placed upon clearly illustrating the principles of the multifunction portable electronic device and the anti-theft method thereof.

FIG. 1 shows a block diagram of a multifunctional portable electronic device, according to an exemplary embodiment.

FIG. 2 shows a block diagram of the multifunctional portable electronic device when the transmitting unit is connected to the receiving module to recharge.

FIG. 3 shows a flow chart of an anti-theft process of the multifunctional portable electronic device shown in FIG. 1.

### DETAILED DESCRIPTION

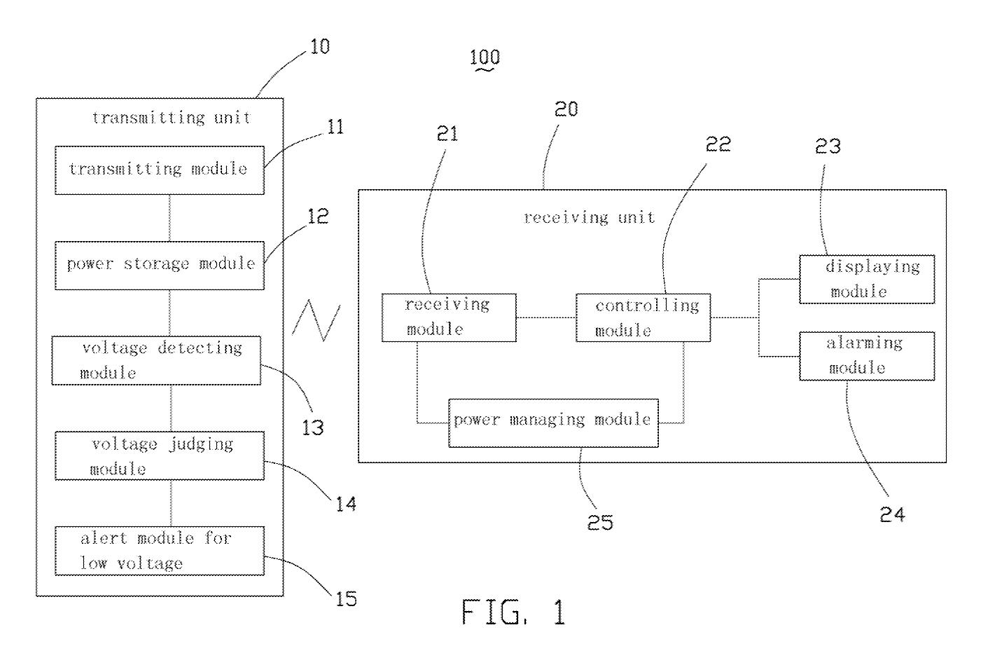

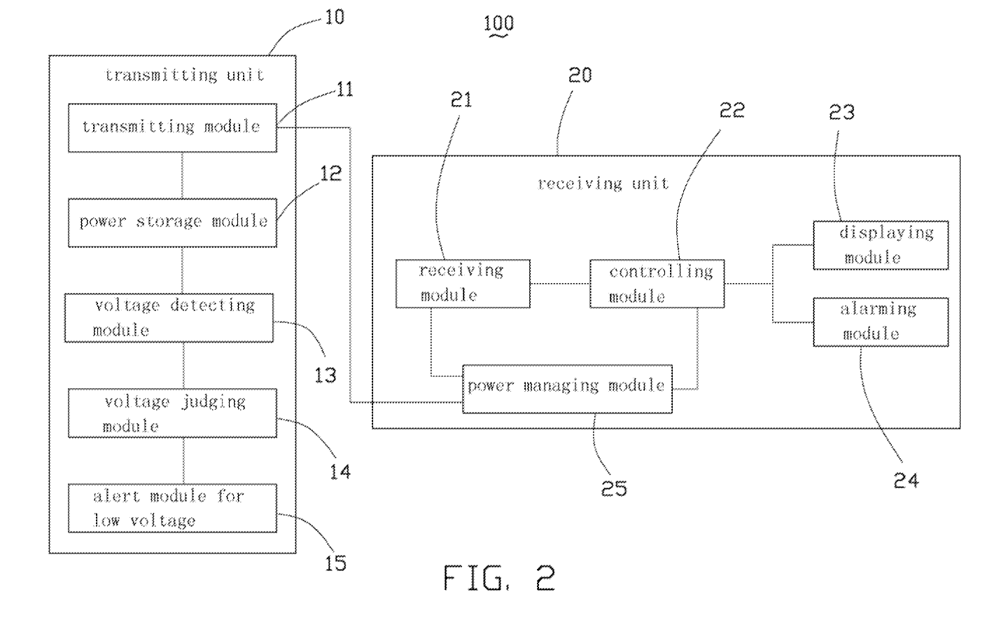

Referring to FIG. 1, a multifunctional portable electronic device 100 such as a mobile phone or a personal digital assistant (PDA) includes a transmitting unit 10 and a receiving unit 20. The transmitting unit 10 is separate from the receiving unit 20. A wireless communication connection can be established between the transmitting unit 10 and the receiving unit 20 by frequency modulation (FM), Bluetooth transmission, or infrared transmission. Referring to FIG. 2, the transmitting unit 10 also can electronically connect to the receiving unit 20 to recharge.

The transmitting unit 10 includes a transmitting module 11, a power storage module 12, a voltage detecting module 13, a voltage judging module 14 and an alert module for low voltage 15 electrically connected together in series. The transmitting module 11 is used to communicate with the receiving unit 20 by sending signals to the receiving unit 20. The power storage module 12 supplies power to the transmitting module 11. A switch (not shown) can be set between the power storage module 12 and the transmitting module 11. Users can turn on/off the transmitting module 11 via controlling the switch. The voltage detecting module 13 obtains the output voltage of the power storage module 12 and sends the obtained output voltage to the voltage judging module 14. The voltage judging module 14 has predetermined a work voltage of the transmitting module 11. The voltage judging module 14 judges whether the voltage of the power storage module 12 is lower than the predetermined work voltage and activates the alert module for low voltage 15 when the voltage of power storage module 12 is lower than the predetermined work voltage. The alert module for low voltage 15 generates an alert signal (e.g. sounds, light indications, etc) to users to recharge the transmitting unit 10 after being activated by the voltage judging module 14.

The receiving unit 20 includes a receiving module 21, a controlling module 22, a displaying module 23, an alarming module 24, and a power managing module 25. The receiving module 21, the displaying module 23, the alarming module 24 are electrically connected to the controlling module 22. The power managing module 25 is electrically connected to the receiving module 21, the controlling module 22, the displaying module 23, and the alarming module 24.

The receiving module 21 is used to communicate with the transmitting module 11 by receiving the signals therefrom. The controlling module 22 has a maximum predetermined work distance from the receiving module 21. The receiving module 21 can communicates with the transmitting module 11 freely and receives signals from the transmitting module 11 within the predetermined work distance. The receiving module 21 may can not receives signals or receive weak signals from the transmitting module 11 outside the predetermined work distance. The predetermined work distance can be changed by users according to different requirements. The controlling module 22 judges whether the distance from the receiving module 21 to the transmitting module 11 is over the predetermined work distance according to the intensity of signals received from the transmitting module 11 via the receiving module 21. The controlling module 22 also controls the displaying module 23 to display the communication connection states between the receiving module 21 and transmitting module 11. In addition, the controlling module 22 sends alarming signals to the alarming module 24 when the distance from the receiving module 21 to the transmitting module 11 is over the predetermined work distance.

The displaying module 23 displays the communication connection states between the transmitting module 11 and the receiving module 21. The alarming module 24 generates an alert signal to users when the distance between the transmitting module 11 and receiving module 21 is over the predetermined work distance. The power managing module 25 supplies power to the receiving module 21 and the controlling module 22. Referring to FIG. 2, the power managing module 25 can be connected to the transmitting module 11 by a wire when the transmitting module 11 is out of power, to charge the transmitting module 11.

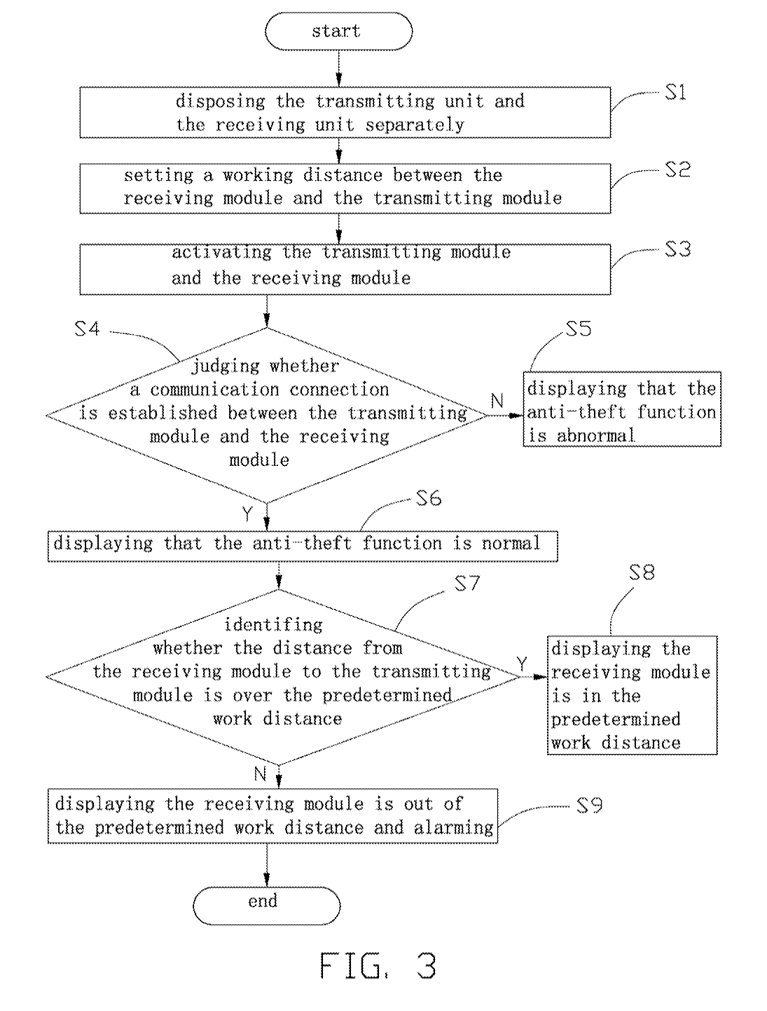

Referring to FIG. 3, the anti-theft process of the multifunctional portable electronic device 100 may include following steps:

In step S1, disposing the transmitting unit 10 and the receiving unit 20 separately. For example, in a first condition, users can put the transmitting unit 10 in the bag, and carry the receiving unit 20 with them. In a second condition, the transmitting unit 10 and the receiving unit 20 are carried by two users.

In step S2, a working distance between the receiving module 21 and the transmitting module 11 is set using the controlling module 22 according to different conditions. For example, in the first condition, the distance may be 0.5 to 1 meter, and in the second condition, the distance may be 500 meter.

In step S3, activating the transmitting module 11 and the receiving module 21 to communicate with each other.

In step S4, the controlling module 22 judges whether a communication connection is established between the transmitting module 11 and the receiving module 21, if yes, the process goes to S6, if no, the process goes to S5.

In step S5, the controlling module 22 controls the displaying module 23 to display that the anti-theft function of the portable electronic device 100 is abnormal.

In step S6, the controlling module 22 controls the displaying module 23 to display the anti-theft function of the portable electronic device 100 is normal, the process goes to S7.

In step S7, the controlling module 22 identifies whether the distance from the receiving module 21 to the transmitting module 11 is over the predetermined work distance according to the intensity of signals received from the transmitting module 11 via the receiving module 21, if yes, the process goes to S8, if no, the process goes to S9.

In step S8, the control unit 30 controls the displaying module 23 to display that the receiving module 21 is in the predetermined work distance.

In step S9, the control unit 30 controls the displaying module 23 to display that the receiving module 21 is outside of the predetermined work distance, and controls the alarming module to generate an alarming signals to users.

The portable electronic device 100 can generate an alarming signal to users via the transmitting unit 10 when the receiving unit 20 is over the predetermined work distance, and avoid the portable electronic device 100 to be lost or stolen.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A multifunctional portable electronic device, comprising:
a transmitting unit; and
a receiving unit separate from the transmitting unit, wherein the receiving unit can communicate with the transmitting unit within a predetermined work distance, and generate an alarming signal when the transmitting unit is outside of the predetermined work distance.

2. The multifunctional portable electronic device as claimed in claim 1, wherein the receiving unit includes a receiving module, a controlling module, and an alarming module, the receiving module and the alarming module are electrically connected to the controlling module, the receiving module can communicate with the transmitting unit, the controlling module has predetermined work distance therein, and controls the alarming module to generating an alarming signal when the distance between the receiving module and the transmitting unit is over the predetermined work distance.

3. The multifunctional portable electronic device as claimed in claim 2, wherein the receiving module further includes a power managing module, one end of the power managing module is connected to the receiving module, another end of the power managing module is connected to the controlling module, and the power managing module supplies power to the receiving module and the controlling module.

4. The multifunctional portable electronic device as claimed in claim 3, wherein the transmitting unit includes a transmitting module and a power storage module connected to the transmitting module, the transmitting module can communicate with the receiving module, the power storage module is able to connect to the power managing module to recharge when the power storied therein is low.

5. The multifunctional portable electronic device as claimed in claim 4, wherein the transmitting unit includes a voltage detecting module, a voltage judging module and an alert module for low voltage electrically connected in series, the voltage detecting module is connected to the power storage unit to obtain the voltage of the power storage module, the voltage judging module has predetermined work a voltage therein and controls the alert module generate an alarming signal when the voltage of the power storage is lower than the predetermined work voltage.

6. An anti-theft method of portable electronic devices, comprising:
providing a transmitting unit and a receiving unit separate from the transmitting unit, and able to communicate with the transmitting unit;
placing the transmitting unit and the receiving unit separately;
setting a working distance between the receiving unit and the transmitting unit; and
alarming when the distance between the receiving unit and the transmitting unit is outside of the working distance distance.

7. The anti-theft method of portable electronic devices as claimed in claim 6, wherein the transmitting unit communicates with the receiving unit by FM, Bluetooth transmission, or infrared transmission.

8. The anti-theft method of portable electronic devices as claimed in claim 6, further comprising a step of identifying whether the distance from the receiving module to the transmitting module is over the working distance according to the intensity of signals received from the transmitting module.
